(19) United States
(12) Patent Application Publication
(10) Pub. No.: US 2013/0253751 A1
(43) Pub. Date: Sep. 26, 2013

(54) SYSTEM AND METHOD FOR CONTROLLIJNG AUTONOMOUS PLATFORM USING WIRE

(71) Applicants: Yun-Seo Choi, Daejeon (KR); Gap Joo Woo, Daejeon (KR); Jong Ho Eun, Daejeon (KR)

(72) Inventors: Yun-Seo Choi, Daejeon (KR); Gap Joo Woo, Daejeon (KR); Jong Ho Eun, Daejeon (KR)

(21) Appl. No.: 13/989,337

(22) PCT Filed: Nov. 23, 2011
(86) PCT No.: PCT/KR2011/008983

§ 371 Date: May 23, 2013

(30) Foreign Application Priority Data
Nov. 24, 2010 (KR) 10-2010-0117504
Nov. 25, 2010 (KR) 10-2010-0118173

(51) Int. Cl. B25J 11/00; B25J 9/10

(52) U.S. Cl. CPC B25J 11/00; B25J 9/104
USPC 701/23

(57) ABSTRACT

Disclosed are a system and method for controlling an autonomous platform using a wire. According to one embodiment of the present invention, an autonomous platform control system for controlling an autonomous platform connected to a wire comprises: a route setting unit which generates movement control information of the autonomous platform using final position information and first position information; a speed management unit which moves the autonomous platform by controlling the speed of the autonomous platform using the movement control information; a processing unit which generates current position information by setting the position and posture of the autonomous platform using a measurement value of a rotation angle of the wire with respect to the moved autonomous platform, and generates wire operation length information by setting the length of the wire using the current position information; and a sagging management unit which determines the sagging of the wire using measurement information on a wire tension acting on the wire, and adjusts the wire using the measurement information on the wire tension when the wire sags.

### TECHNICAL FIELD

The present invention relates to a system for controlling an autonomous platform, more specifically to a system and method for controlling an autonomous platform using a wire.

### BACKGROUND ART

As vessels become increasingly bigger, blocks that form the hull are also increasingly getting bigger. Generally, the hull of a large vessel is constructed by manufacturing the blocks, which constitute portions of the hull, and then assembling the blocks. In other words, after rust or foreign substances on surfaces of raw materials are blasted off and the raw materials are painted for prevention of corrosion, the raw materials are, for example, welded together to build the blocks, and the blocks are assembled with one another to complete the hull.

These blocks need to be welded, blasted and painted inside thereof. Accordingly, various tasks, such as collecting the grits used for blasting, drying/inspecting/measuring paint film after painting, etc., are also performed inside the blocks. Various kinds of automated preparations for welding, painting and inspection have been steadily developed in order to improve the work efficiency inside the blocks. Demanded as a result is an apparatus for freely moving the devices required for the tasks to desired positions inside the block so that the tasks performed inside the block can be easily carried out. The most well-known apparatus for freely moving inside the block is an autonomous platform using a wire.

The conventional autonomous platform using a tendon has not only a wider work radius than the Stewart platform using a linear actuator but also stronger characteristics against a very heavy load.

It has been only possible to control the position and posture of such an autonomous platform under a weightless condition (i.e. a condition in which no load is applied) in order to prevent the wire from being stretched. However, in the case that the autonomous platform using a wire is under a load, the wire becomes stretched due to the weight of the autonomous platform, making the wire to sag. If the autonomous platform is disturbed while the wire is sagged, it becomes difficult to maintain the position and posture of the autonomous platform.

Moreover, since the autonomous platform itself has its own weight while a load is applied, the wire gets stretched, and thus it is not easy to move the autonomous platform to a desired position and posture, thereby occurring errors when the welding, painting and inspection are performed.

### DISCLOSURE

### Technical Problem

An embodiment of the present invention provides a system and method for controlling an autonomous platform using a wire that can prevent the wire connected to the autonomous platform from sagging.

An embodiment of the present invention provides a system and method for controlling an autonomous platform using a wire that can control the tension acting on the wire.

An embodiment of the present invention provides a system and method for controlling an autonomous platform using a wire that can accurately determine a length of the wire fixed to the autonomous platform and a block.

An embodiment of the present invention provides a system and method for controlling an autonomous platform using a wire that can determine an accurate position and posture of the autonomous platform inside the block by use of the tension acting on the wire.

### Technical Solution

An aspect of the present invention features a system for controlling an autonomous platform connected with a wire.

A system for controlling an autonomous platform connected with a wire in accordance with an embodiment of the present invention includes: a route setting unit configured to generate movement control information by using final position information and initial position information; a speed management unit configured to move the autonomous platform by controlling a speed of the autonomous platform by use of the movement control information; a processing unit configured to generate current position information by using a rotation angle measurement value with respect to the wire and the moved autonomous platform and configured to generate wire operation length information by using the current position information and the movement control information; and a sagging management unit configured to determine sagging of the wire by using measurement information of wire tension acting on the wire once the wire operation length information is generated and configured to adjust the wire by using the measurement information of wire tension if it is determined that the sagging of the wire has occurred.

The sagging management unit can set tension reference information, which becomes a reference for determining the sagging of the wire, and determine that the wire has sagged if the measurement information of wire tension is smaller than the tension reference information; and adjust the wire by using the wire tension measurement information.

The sagging management unit can generate tension comparison information by comparing the measurement information of wire tension with the tension reference information and pull the wire by using the tension comparison information.

The processing unit can include: a wire management module configured to generate current length information of the wire by setting a length of the wire by use of the rotation angle measurement value; a position management module configured to generate the current position information by using the current length information of the wire; a length management module configured to generate the wire operation length information by using the current position information and moved position information of the movement control information; and a winch control module configured to move the autonomous platform, for which the sagging of the wire is solved, by winding or unwinding the wire by controlling a winch by use of the wire operation length information. The moved position information can refer to a position and posture to which the autonomous platform needs to move per unit time.

The wire management module can include: a rotation angle analysis module configured to generate the current length information of the wire by using the rotation angle measurement value measured through an encoder that is conned to the wire; and a tension analysis module configured to generate tension measurement information by using a tension measurement value measured through a load cell that is connected to the wire.

The position management module can include: a prediction module configured to set arbitrary position information, which indicates an arbitrary position within a block in which the autonomous platform is placed, and arbitrary length information of the wire by using the arbitrary position information; and a generation module configure to the current position information by using the arbitrary length information of the wire and the current length information of the wire.

The generation module can generate a length difference value by comparing the arbitrary length information of the wire with the current length information of the wire, determine whether the length difference value is smaller than the length reference information, and generate the current position information with the arbitrary position information if the length difference value is determined to be smaller than the length reference information.

The generation module can re-set the arbitrary position information by using the length difference value if the length difference value is determined to be greater than or equal to the length reference information.

Moreover, an aspect of the present invention features a system for controlling an autonomous platform connected with a wire.

A system for controlling an autonomous platform connected with a wire in accordance with an embodiment of the present invention includes: a route setting unit configured to set movement control information by using final position information and initial position information; a speed management unit configured to move the autonomous platform by controlling a speed of the autonomous platform by use of the movement control information; a position management unit configured to generate current length information of the wire by using rotation angle measurement information with respect to the wire and the moved autonomous platform and by using wire tension information acting on the wire and configured to generate current position information of the moved autonomous platform by using the current length information of the wire; and a processing unit configured to generate wire operation length information by using the current position information and the movement control information and generate rotation angle control information by using the wire operation length information and the rotation angle measurement information.

The movement control information can include at least one of movement speed information, at which the autonomous platform needs to move per unit time, and moved position information.

The processing unit can include: an analysis module configured to generate the wire operation length information by using the current position information and the moved position information; a prediction module configured to generate rotation angle prediction information by using the wire operation length information; and a determination module configured to generate the rotation angle control information by comparing the rotation angle prediction information with the rotation angle measurement information.

The prediction module can generate tension prediction information corresponding to the wire operation length information and generate the rotation angle prediction information by using the wire operation length information and the tension prediction information.

The position management unit can include: a rotation angle analysis module configured to generate base length information of the wire by using the rotation angle measurement information that is measured through an encoder connected to the wire; a tension analysis module configured to generate the wire tension information by using tension measurement information that is measured through a load cell connected to the wire; and a length setting module configured to generate the current length information of the wire by setting a length of the wire by using the base length information of the wire and the wire tension information.

The position management unit can also include: an operation module configured to set arbitrary position information indicating a position where the autonomous platform is placed within a block and set arbitrary length information by using the arbitrary position information; and a generation module configured to generate a length difference value by comparing the arbitrary length information of the wire with the current length information of the wire and set the arbitrary position information as the current position information if the length difference value is smaller than length reference information.

The generation module can re-set the arbitrary position information by using the length difference value if the length difference value is greater than or equal to the length reference information.

An aspect of the present invention features a method for controlling an autonomous platform by a system for controlling the autonomous platform using a wire.

A method for controlling an autonomous platform using a wire by a system for controlling the autonomous platform using the wire in accordance with an embodiment of the present invention includes: (a) generating movement control information of the autonomous platform by using final position information and initial position information, and moving the autonomous platform by using the movement control information; (b) generating current position information by setting a position and posture of the autonomous platform by using a rotation angle measurement value of a winch connected to the wire; (c) generating wire operation length information by setting a length of the wire by using the current position information; (d) determining sagging of the wire by using measurement information of wire tension acting on the wire, and if the sagging of the wire occurs, adjusting the wire by using the measurement information of wire tension; and (e) moving the wire-sagging solved autonomous platform by controlling a speed of the autonomous platform by using the movement control information.

Said step (d) can include: generating the measurement information of wire tension by measuring a tension of the wire connected to the autonomous platform; setting tension reference information which becomes a reference for determining sagging of the wire; and determining that the wire is sagged if the measurement information of wire tension is smaller than the tension reference information, and adjusting the wire by using the measurement information of wire tension.

Said step (b) can include: (b1) generating current length information of the wire by setting a length of the wire by using the rotation angle measurement value; and (b2) generating the current position information through forward kinematics by using the current length information of the wire.

Said step (b2) can include: setting arbitrary position information indicating an arbitrary position within a block in which the autonomous platform is placed; setting arbitrary length information of the wire by using the arbitrary position information; and generating the current position information by using the arbitrary length information of the wire and the current length information of the wire.

The generating of the current position information by using the arbitrary length information of the wire and the current length information of the wire can include: generating a length difference value by comparing the arbitrary length information of the wire with the current length information of the wire; generating length determination result information by determining whether the length difference value is smaller than length reference information; and generating the current position information with the arbitrary position information if the length determination result information shows that the length difference value is smaller than the length reference information.

The generating of the current position information by using the arbitrary length information of the wire and the current length information of the wire can also include re-setting the arbitrary position information by using the length difference value if the length determination result shows that the length difference value is greater than or equal to the reference information.

Said step (c) can include generating the wire operation length information through inverse kinematics by using the current position information.

An aspect of the present invention features a method for controlling an autonomous platform by a system for controlling the autonomous platform using a wire.

A method for controlling an autonomous platform using a wire by a system for controlling the autonomous platform using the wire in accordance with an embodiment of the present invention includes: (a) setting movement control information by using final position information and initial position information, and moving the autonomous platform by using the movement control information; (b) generating current length information of the wire by using rotation angle measurement information with respect to the wire and the moved autonomous platform and wire tension information acting on the wire; (c) generating current position information of the moved autonomous platform by using the current length information of the wire; (d) generating wire operation length information by using the current position information and the movement control information; (e) moving the autonomous platform by using rotation angle control information setting the wire operation length information and the rotation angle measurement information.

Said step (a) can include: setting the movement control information comprising at least one of movement speed information, at which the autonomous platform needs to move per unit time, and moved position information by using the final position information and the initial position information; and moving the autonomous platform by using the movement control information.

Said step (e) can include: generating tension prediction information corresponding to the wire operation length information; generating rotation angle prediction information by using the wire operation length information and the tension prediction information; and generating the rotation angle control information by comparing the rotation angle prediction information with the rotation angle measurement information.

Said step (d) can include generating the wire operation length information through inverse kinematics by using the current position information and the moved position information.

Said step (b) can include: generating base length information of the wire by using the rotation angle measurement information measured through an encoder connected to the wire; generating the wire tension information by using tension measurement information measured through a load cell connected to the wire; and generating the current length information of the wire by setting a length of the wire by using the base length information of the wire and the wire tension information.

Said step (c) can include generating the current position information through forward kinematics by using the current length information of the wire.

Said step (c) can include: setting arbitrary position information where the autonomous platform is placed within a block; setting arbitrary length information of the wire by using the arbitrary position information; generating a length difference value by comparing the arbitrary length information of the wire with the current length information of the wire; and generating the current position information with the length difference value and the arbitrary position information if the length difference value is smaller than length reference information.

### DESCRIPTION OF DRAWINGS

FIG. 1 is a block diagram illustrating a system for controlling an autonomous platform using a wire in accordance with an embodiment of the present invention.

FIG. 2 is a block diagram illustrating a detailed configuration of a processing unit of a system for controlling an autonomous platform using a wire in accordance with an embodiment of the present invention.

FIGS. 3 and 4 are detailed flow diagrams illustrating a method for controlling an autonomous platform using a wire in accordance with an embodiment of the present invention.

FIG. 5 is a block diagram illustrating a system for controlling an autonomous platform using a wire in accordance with an embodiment of the present invention.

FIG. 6 is a block diagram illustrating a detailed configuration of a position management unit of the system for controlling an autonomous platform using a wire shown in FIG. 5.

FIG. 7 is a block diagram illustrating in detail a processing unit of the system for controlling an autonomous platform using a wire shown in FIG. 5.

FIGS. 8 and 9 are detailed flow diagrams illustrating a method for controlling an autonomous platform using a wire in accordance with an embodiment of the present invention.

FIG. 10 shows an example of how current position information is generated in a method for controlling an autonomous platform using a wire in accordance with an embodiment of the present invention.

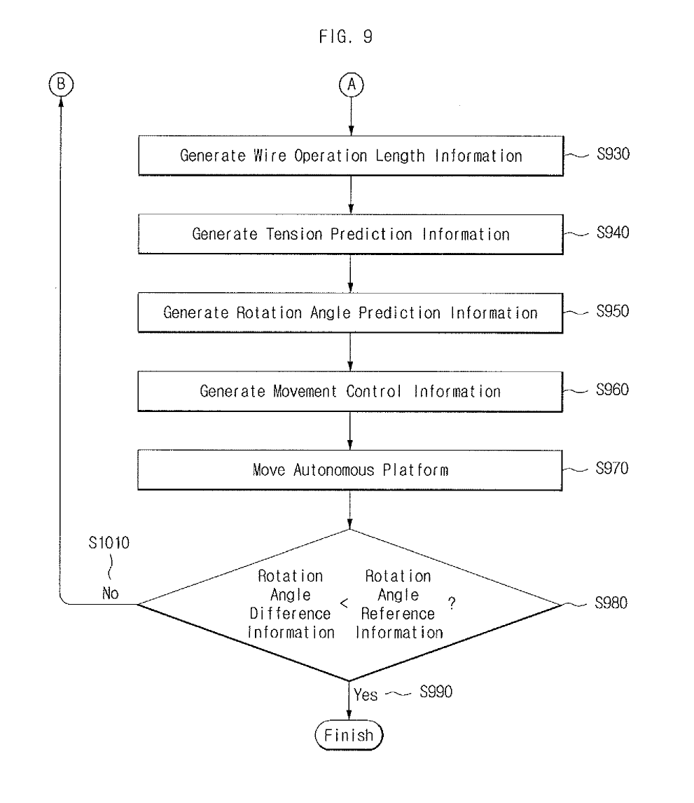

FIG. 11 shows an example of how wire operation length information is generated in a method for controlling an autonomous platform using a wire in accordance with an embodiment of the present invention.

### MODE FOR INVENTION

Hereinafter, a system and method for controlling an autonomous platform using a wire in accordance with an embodiment will be described with reference to the accompanying drawings. In describing the embodiment with reference to the accompanying drawings, any identical or similar elements will be given same reference numerals, and the description thereof will not be redundantly provided.

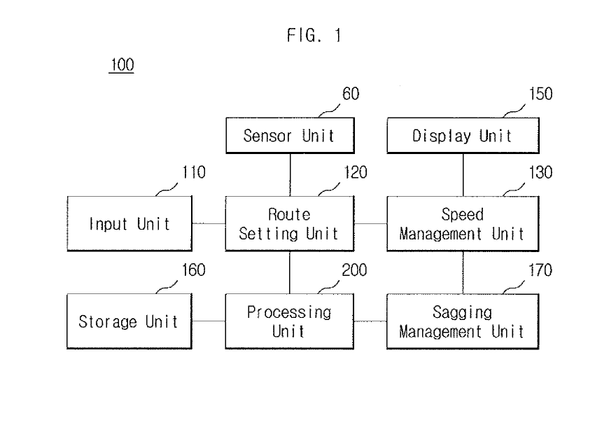

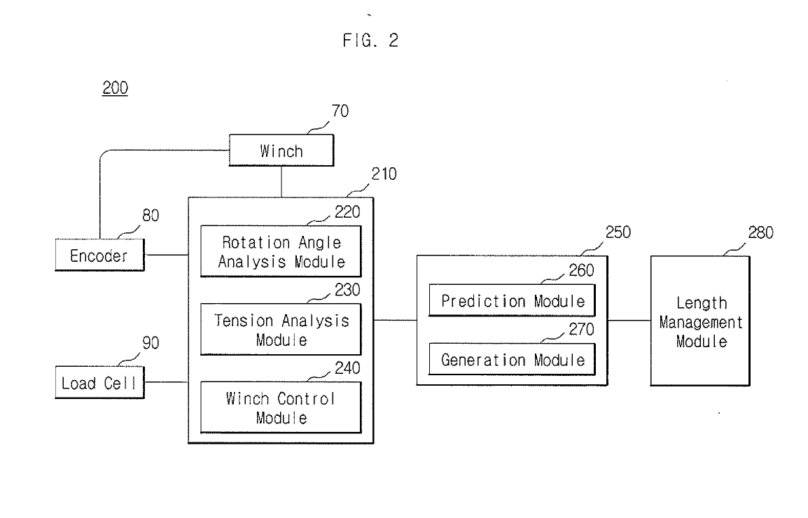

Hereinafter, a system for controlling an autonomous platform using a wire in accordance with an embodiment of the present invention will be described with reference to FIG. 1 and FIG. 2.

FIG. 1 is a block diagram illustrating a system for controlling an autonomous platform using a wire in accordance with an embodiment of the present invention.

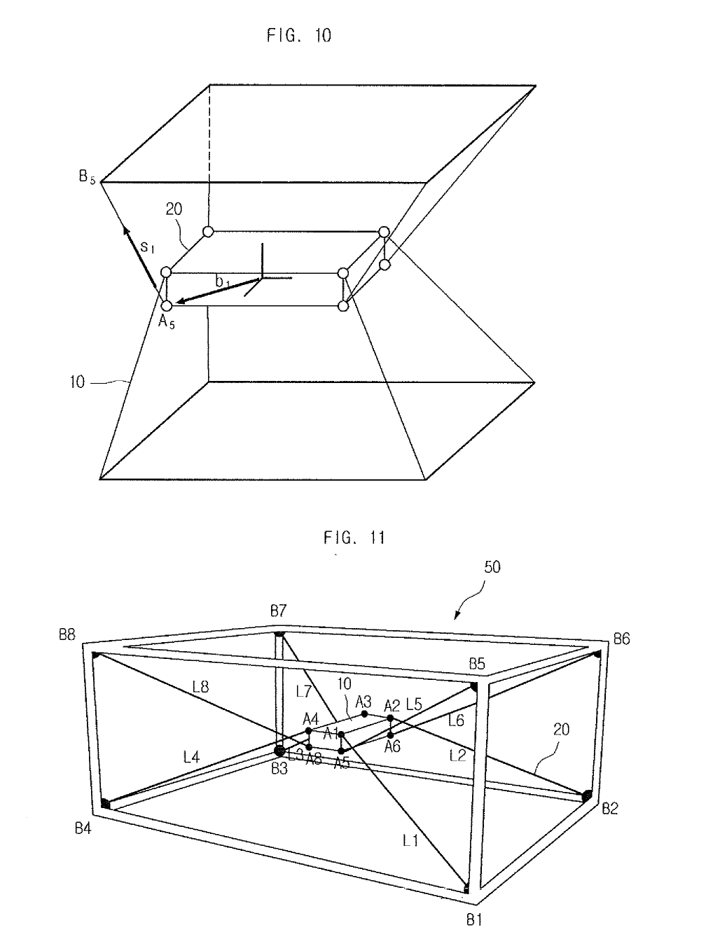

Referring to FIG. 1, a system for controlling an autonomous platform using a wire 100 (referred to as “autonomous platform control system” hereinafter) uses the wire to move the autonomous platform within a block. Here, the autonomous platform 10 is fixed by the wire 20 within the block 50, as illustrated in FIG. 11, and is movable by a plurality of connected wires 20.

Such an autonomous platform 10 can include a mobile platform and a working apparatus, and the working apparatus can include a working robot and a base. Accordingly, the autonomous platform 10 can easily perform welding, blasting, painting and surfacing tasks inside the block 50 while freely moving inside the block 50, which is a work space. Here, the autonomous platform 10 can have eight wires 20 connected thereto.

One end of the wire 20 is coupled with the block 50, and the other end of the wire 20 is coupled to a winch (not shown) that is installed in the autonomous platform 10. Here, the winch can adjust a length of the wire 20 precisely by winding or unwinding the wire 20. Accordingly, the autonomous platform 10 can adjust the length of the wire 20 by use of the winch to be precisely moved to a desired position inside the block 50.

Referring to FIG. 1 again, the autonomous platform control system 100 includes an input unit 110, a route setting unit 120, a speed management unit 130, a processing unit 200, a sagging management unit 170, a display unit 150 and a storage unit 160.

The input unit 110 can have final position information inputted by a user. Here, the final position information indicates a position and posture to which the autonomous platform 10 needs to move eventually in the block 50.

Here, the position of the autonomous platform 10 can be expressed as a coordinate value including x, y and z to indicate where the autonomous platform 10 is positioned in the block 50.

Here, the posture of the autonomous platform 10 can be expressed as an Euler angle including ψ, θ and φ to indicate an angle by which the autonomous platform 10 is tilted with respect to the position of the autonomous platform 10 in the block 50.

That is, the final position information can express the position and posture, to which the autonomous platform 10 needs to move eventually in the block 50, as x, y, z, ψ, θ and φ. The final position information can include at least one of a local coordinate value, which is based on the autonomous platform 10, and a global coordinate value, which is based on any one point within the block 50.

The input unit 110 is a user interface (UI) for having various data inputted by the user, and there is no restriction on how the input unit 110 is realized. For example, the input unit 110 can be any means, such as a keyboard, a touch-pad, a mouse, a key-pad, etc., which can have data inputted thereto.

Meanwhile, the input unit 110 can have the final position information inputted through a macro generated using, for example, CAD/CAM (Computer Aided Design/Computer Aided Manufacturing). Hereinafter, it will be described that the final position information is inputted through the input unit 110 by the user.

The route setting unit 120 generates movement control information of the autonomous platform 10 by use of the final position information and initial position information. Here, the movement control information refers to control information required for moving the autonomous platform 10 from the initial position information to the final position information.

Specifically, the route setting unit 120 generates the initial position information indicating the position and posture of the autonomous platform 10 prior to moving. That is, the initial position information refers to the position and posture before the autonomous platform 10 is repositioned, and a coordinate value including x, y and z can be expressed to indicate the position where the autonomous platform 10 is positioned within the block 50, and an Euler angle including ψ, θ and φ can be expressed to indicate the posture which is an angle by which the autonomous platform 10 is tilted in the block 50.

The route setting unit 120 can use a sensor value inputted through a sensor unit 60 or wire initial length information provided by the processing unit 200 to generate the initial position information.

Here, the sensor unit 60 can be any device that can generate a sensor value by measuring a position and posture in a space. For example, the sensor unit 60 can be at least one of the global positioning system (GPS), an indoor GPS (IGPS) and an ultrasonic sensor.

The route setting unit 120 uses the final position information and the initial position information to determine a movement route through which the autonomous platform 10 needs to move. Here, the movement route refers to a route through which the autonomous platform 10 needs to move from the initial position information to the final position information.

The route setting unit 120 generates movement speed information indicating a speed at which the autonomous platform 10 needs to move through the movement route per unit time. The route setting unit 120 can set acceleration section information, constant speed section information and deceleration section information. The route setting unit 120 generates the movement speed information that includes the acceleration section information, the constant speed section information and the deceleration section information. Here, the route setting unit 120 can set the acceleration section information, the constant speed section information and the deceleration section information by receiving an input from the user through the input unit 110 or by using a predetermined algorithm (e.g., a program, a probability model, etc.).

The route setting unit 120 sets moved position information which indicates a position and posture to which the autonomous platform 10 needs to move per unit time. That is, the moved position information refers to the position and posture to which the autonomous platform 10 needs to have moved after a unit time.

The route setting unit 120 generates the movement control information that includes at least one of the movement speed information and the moved position information. Moreover, the route setting unit 120 can set position unit information, which indicates a position and posture to which the autonomous platform 10 needs to move per unit time, and have the position unit information included in the movement control information. Here, the position unit information refers to information on how much the autonomous platform 10 needs to move per unit time according to the movement speed information.

The speed management unit 130 uses the movement control information to generate wire unit length information to be provided to the processing unit 200 to move the autonomous platform 10. In other words, the speed management unit 130 generates the wire unit length information by setting a length of the wire 20 per unit time, based on the movement control information. The speed management unit 130 provides the wire unit length information to the processing unit 200, which moves the autonomous platform 10 by winding or unwinding the wire 20 connected to a winch 70 by use of the wire unit length information.

Moreover, the speed management unit 130 generates the wire unit length information so as for the sagging management unit 170 to solve sagging of the wire 20 or, if the wire 20 does not sag, uses the movement control information to allow the autonomous platform 10 to move toward the final position information.

The processing unit 200 uses a rotation angle measurement value, from a measured rotation angle of the winch 70 (shown in FIG. 2), to generate current length information of the wire, current position information and wire operation length information. Here, the rotation angle measurement value indicates an angle of the winch 70 when the winch 70 is wound or unwound by the wire 20. In other words, the processing unit 200 uses the rotation angle measurement value of the winch 70 to configure the length of the wire 20 that is unwound from the winch 70 to generate the current length information of the wire.

Here, the current length information of the wire indicates the length of the wire 20 that is unwound from the winch 70, which is the length of the wire 20 connecting between the autonomous platform 10 and the block 50. The current length information of the wire can include a length for each of the plurality of wires 20 connected to the autonomous platform 10. The processing unit 200 that generates the current length information of the wire will be described in detail with reference to FIG. 2.

Moreover, the processing unit 200 uses the current length information of the wire to configure a position and posture of the autonomous platform 10 and generate the current position information. Here, the current position information refers to a position and posture of the autonomous platform 10 that is moved by the speed management unit 130 within the block 50. The current position information can be expressed with a coordinate value such as x, y and z to indicate the position of the autonomous platform 10 and with an Euler angle such as ψ, θ and φ to indicate the posture of the autonomous platform 10.

The processing unit 200 uses the current position information and the movement control information to generate the wire operation length information. Here, the wire operation length information refers to a length of the wire 20 corresponding to a position and posture to which the autonomous platform 10 needs to move based on the current position information and the movement control information. The processing unit 200 will be described in more detail with reference to FIG. 2.

The sagging management unit 170 uses measurement information of wire tension to determine whether the wire 20 is sagging or not and, if sagging of the wire 20 occurs, adjusts the wire by use of the wire tension measurement information.

Specifically, the sagging management unit 170 has the measurement information of wire tension provided thereto from the processing unit 200. Here, the measurement information of wire tension refers to a tension applied to the wire 20 and can include tension information for each of the plurality of wires 20 connected to the autonomous platform 10.

The sagging management unit 170 sets tension reference information that becomes a reference for a tension applied to the wire 20 in order to determine the sagging of the wire 20. The sagging management unit 170 can set the tension reference information by either receiving the tension reference information from the input unit 100 or using a pre-determined algorithm. For example, the sagging management unit 170 can set the tension reference information by using block design information.

Here, the block design information refers to information configured when the block 50 is designed in order to fix the autonomous platform 10 in the block, and can include a wire fixing position value for a position at which the wire 20 is fixed to the autonomous platform 10, a block fixing position value for a position at which the wire 20 is fixed to the block 50, and physical property information such as the size of the autonomous platform 10. The block design information can be set by having the block design information inputted from the user through the input unit 110 or set by the sagging management unit 170 after receiving the block design information from an external device (not shown) that is connected with the autonomous platform control system 100.

The sagging management unit 170 uses the measurement information of wire tension and the tension reference information to determine the sagging of the wire 20. Specifically, the sagging management unit 170 determines that the wire 20 is sagged if the measurement information of wire tension is smaller than the tension reference information. Since the tension reference information refers to a minimum tension to be applied to the wire in order not to have any sagging occur in the wire 20, it can be determined that the wire 20 is sagged if the measurement information of wire tension is smaller than the tension reference information.

The sagging management unit 170 generates tension comparison information by comparing the measurement information of wire tension with the tension reference information. The sagging management unit 170 provides the tension comparison information to the processing unit 200. Here, the processing unit 200 can use the tension comparison information to pull the wire 20 and prevent the wire 20 from sagging.

The display unit 150 can display steps carried out and results outputted by the input unit 110, the route setting unit 120, the speed management unit 130, the processing unit 200 and the sagging management unit 170 and can display data stored in the storage unit 160.

For example, the display unit 150 can display a user interface in order to have movement initial information inputted by the user. The user can check displayed information through the display unit 150 and input the movement initial information through the input unit 110.

In another example, the display unit 150 can display the steps and results of having the initial position information set and the movement control information generated by the route setting unit 120.

In another example, the display unit 150 can display the steps and results of having the current length information of the wire, the current position information and the wire operation length information generated by the processing unit 200.

In another example, the display unit 150 can display the sensor value measured by the sensor unit 60.

Moreover, the display unit 150 can display any error occurred in the input unit 110, the route setting unit 120, the speed management unit 130, the processing unit 200 and the sagging management unit 170. Accordingly, the user can check the error displayed through the display unit 150 and solve the error.

The display unit 150 can be any one of a cathode ray tube, a liquid crystal display (LCD), an organic light emitting display (OLED), a light emitted diode (LED), an electrophoretic display (EPD), a plasma display panel (PDP), etc. or can be a computer having a display device. Moreover, the display unit 150 can be realized integrally with the input unit 110 by use of, for example, a touch screen.

The storage unit 160 stores data required by the input unit 110, the route setting unit 120, the speed management unit 130, the processing unit 200 and the sagging management unit 170 of the autonomous platform 100 and data generated by the input unit 110, the route setting unit 120, the speed management unit 130, the processing unit 200 and the sagging management unit 170.

For example, the storage unit 160 can store the final position information inputted from the input unit 110 and store the initial position information configured by and the movement control information generated by the route setting unit 120.

In another example, the storage unit 160 can store the sensor value measured by the sensor unit 60 and store the current length information of the wire, the current position information and the wire operation length information generated by the processing unit 200.

The storage unit 160 can provide data required by a request of the input unit 110, the route setting unit 120, the speed management unit 130, the processing unit 200, the sagging management unit 170 and the display unit 150. The storage unit 160 can be provided as a unified memory or constituted with a plurality of memories. For example, the storage unit 160 can be constituted with Read Only Memory (ROM), Random Access Memory (RAM), flash memory, etc.

FIG. 2 is a block diagram illustrating a detailed configuration of the processing unit of the system for controlling an autonomous platform using a wire in accordance with an embodiment of the present invention.

Referring to FIG. 2, the processing unit 200 includes a wire management module 210, a position management module 250 and a length management module 280.

The wire management module 210 uses the rotation angle measurement value to configure the length of the wire 20 and generate the current length information of the wire. This wire management module 210 includes a rotation angle analysis module 220, a tension analysis module 230 and a winch control module 240.

The rotation angle analysis module 220 uses the rotation angle measurement value of the winch 70 that is measured by an encoder 80 to generate the current length information of the wire that indicates the length of the wire 20 unwound from the winch 70.

For example, the rotation angle analysis module 220 can express a relation between the rotation angle measurement value and length information of the wire 20 as a function and insert the rotation angle measurement value in the function to generate the current length information of the wire. It is also possible for the rotation angle analysis module 220 to generate the current length information of the wire by use of a length table in which lengths of the wire 20 are matched to rotation angle measurement values. The rotation angle analysis module 220 provides the current length information of the wire to the position management module 250.

Here, the encoder 80 is connected to the winch 70 and generates the rotation angle measurement value through a rotation of the winch 70. Moreover, the encoder 80 is connected to a pulley (not shown) that discharges the wire 20 to measure how much the pulley is rotated or to generate the rotation angle measurement value by measuring an amount of the discharged wire 20.

Moreover, once a length request signal is received from the route setting unit 120, the rotation angle analysis module 220 generates the wire initial length information by use of the rotation angle measurement value of the encoder 80 connected to the wire 20 of the autonomous platform 10 before moving.

The tension analysis module 230 generates the measurement information of wire tension by use of a tension measurement value measured at a load cell 90.

For example, the tension analysis module 230 can express a relation between the tension measurement value measured at the load cell 90 and a wire tension acting on the wire 20 as a linear or non-linear function and can generate the measurement information of wire tension by inserting the tension measurement value in the function. It is also possible for the tension analysis module 230 to generate the tension measurement information by use of a tension table in which wire tensions are matched to tension measurement values.

Here, the load cell 90 is connected to the wire 20 and generates the tension measurement value by measuring the tension acting on the wire 20. The load cell 90 is accessed to the processing unit 200 and sends the tension measurement value to the tension analysis module 230 of the processing unit 200.

The winch control module 240 is accessed with the winch 70 and controls the winch 70 on which the wire 20 is wound to adjust the length of the wire 20 and move the autonomous platform 10 connected to the wire 20. For example, the winch control module 240 can use the wire unit length information provided by the speed management unit 130 to control the winch 70 and move the autonomous platform 10 by winding or unwinding the wire 20. The winch control module 240 can use the tension comparison information provided by the sagging management unit 170 to solve the sagging of the wire 20 by winding or unwinding the wire 20 connected to the winch 70.

The position management module 250 uses the current length information of the wire to generate the current position information. For this, the position management module 250 includes a prediction module 260 and a generation module 270.

The prediction module 260 uses arbitrary position information to set arbitrary length information of the wire. That is, the prediction module 260 sets the arbitrary position information in order to assume that the autonomous platform 10 is at the arbitrary position within the fixed block 50. Here, the arbitrary position information is expressed as a coordinate value to indicate a position at which the autonomous platform 10 is virtually positioned within the block 50. The arbitrary position information can be any position in the block 50 as long as the autonomous platform 10 can move within the block 50. The arbitrary position information can be set by the prediction module 260 by having the arbitrary position information inputted by the user through the input unit 110 or by using a predetermined algorithm.

The prediction module 260 uses the arbitrary position information to set the arbitrary length information through inverse kinematics. Here, the arbitrary length information of the wire refers to a length of the wire 20 connecting the block 50 to the autonomous platform 10 that is placed at the arbitrary position information.

The generation module 270 uses the arbitrary length information of the wire and the current length information of the wire to generate the current position information through forward kinematics. That is, the generation module 270 generates a length difference value by comparing the arbitrary length information of the wire and the current length information of the wire. The generation module 270 sets length reference information, which is a reference for tolerating an error. Here, the generation module 270 can set the length reference information by having the length reference information inputted by the user through the input unit 110 or by using a predetermined algorithm.

The generation module 270 can generate length determination result information by determining whether the length difference value is smaller than the length reference information. The generation module 270 generates the current position information to be the arbitrary position information if the length determination result information shows that the length difference value is smaller than the length reference information.

The generation module 270 generates the current position information by re-setting the arbitrary position information if the length determination result information shows that the length difference value is greater than or equal to the length difference information.

The length management module 280 uses the current position information and the movement control information to generate the wire operation length information. That is, the length management module 280 generates position difference information by comparing the current position information with the moved position information included in the movement control information in order to determine whether the autonomous platform 10 has moved based on the movement control information set by the route setting unit 120.

The length management module 280 generates the wire fixing position value by adding the current position information, the position difference information and the position unit information with one another. Moreover, the length management module 280 can substitute the wire fixing position value in inverse kinematics to generate the wire operation length information.

The length management module 280 uses the wire operation length information to generate rotation angle prediction information. Here, the rotation angle prediction information refers to a rotation angle of the winch 70 for moving the autonomous platform 10. The length management module 280 generates the movement control information by comparing the rotation angle measurement value with the rotation angle prediction information in order to move the autonomous platform 10 from the current position and posture of the autonomous platform 10 to a position and posture to which the autonomous platform 10 needs to move.

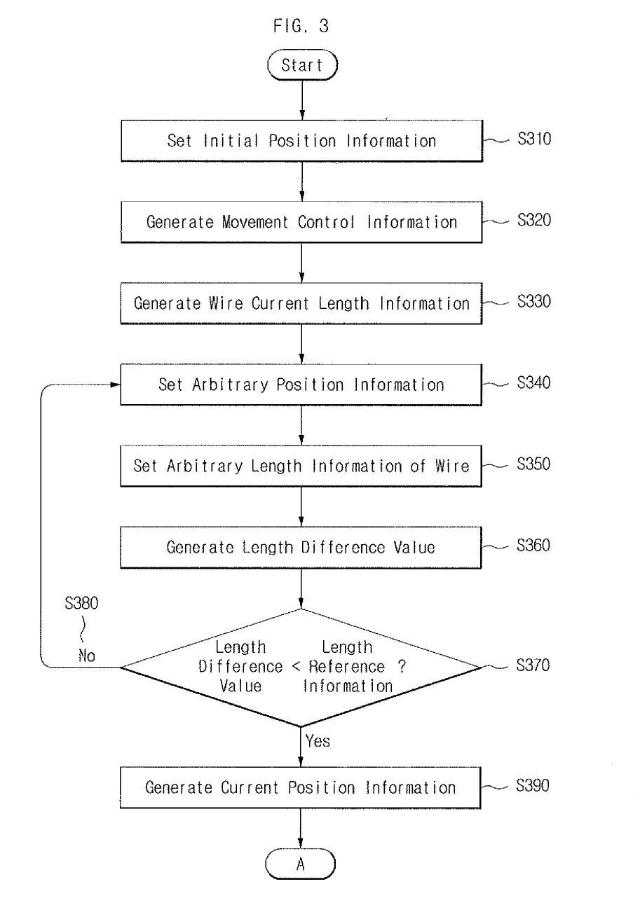

A method for allowing the autonomous platform control system using a wire in accordance with an embodiment of the present invention to control the autonomous platform will be described with reference to FIGS. 3 and 4.

FIGS. 3 and 4 are detailed flow diagrams illustrating a method for controlling an autonomous platform using a wire in accordance with an embodiment of the present invention.

Referring to FIGS. 3 and 4, the autonomous platform control system 100 generates the initial position information, using a sensor value measured by the sensor unit 60 or the wire initial length information (S310).

The autonomous platform control system 100 generates the movement control information including at least one of the movement speed information, the moved position information and the position unit information, using the final position information and the initial position information (S320).

Then, the autonomous platform control system 100 uses the movement control information to generate the wire unit length information and moves the autonomous platform 10 by loosening or pulling the plurality of wires 20 connected to the autonomous platform 10 according to the wire unit length information.

The autonomous platform control system 100 generates the current length information of the wire, using the rotation angle measurement value of the winch 70 (S330).

The autonomous platform control system 100 sets arbitrary position information that indicates an arbitrary position at which the autonomous platform 10 is positioned in the block 50 (S340).

The autonomous platform control system 100 sets the arbitrary length information of the wire by substituting the arbitrary position information in inverse kinematics (S350).

The autonomous platform control system 100 generates the length difference value by comparing the current length information of the wire with the arbitrary length information of the wire (S360). Specifically, the generation module 270 can define the length difference value as shown in [Equation 1].

D=Lₘ−Lₖ [Equation 1]

Here, D is a length difference value, and Lₘ is current length information of the wire, and Lₖ is arbitrary length information of the wire. Accordingly, the generation module 270 of the autonomous platform control system 100 generates the length difference value by inputting the current length information of the wire generated by the rotation angle analysis module 220 in Lₘ of [Equation 1] and inputting the arbitrary length information of the wire set by the prediction module 260 in Lₖ of [Equation 1]. Here, the generation module 270 can generate the length difference value to correspond to each of the plurality of wires 20 connected to the autonomous platform 10.

The autonomous platform control system 100 determines whether the length difference value is smaller than the length reference information (S370).

The autonomous platform control system 100 can re-set the arbitrary position information by returning to step S340 if the length difference value is determined to be greater than or equal to the length reference information (S380).

The autonomous platform control system 100 generates the current position information by use of the arbitrary position information and the length difference value if the length difference value is determined to be smaller than the length reference information (S390).

That is, the generation module 270 of the autonomous platform control system 100 can generate the current position information by use of [Equation 2].

Xₖ₊₁=Xₖ+JM^{#}[D] [Equation 2]

Here, Xₖ₊₁ refers to a position and posture to which the autonomous platform 10 moves using the movement control information with respect to Xₖ, which is arbitrary position information, and JM is the Jacobian matrix that is determined by the kinematic shape of the wire 20, and D is a length difference value.

The generation module 270 can convert [Equation 2] to [Equation 3].

JM_{X}\dot{X}=JM_{L}\dot{L} [Equation 3]

Here, JM_{X}\dot{X} means that a value obtained by subtracting Xₖ from Xₖ₊₁ is differentiated, and JM_{L}\dot{L} means that a value obtained by subtracting Lₖ from Lₘ is differentiated. Afterwards, the generation module 270 can convert [Equation 3] to [Equation 4] in order to generate the current position information.

$$JM = {JM}_{L}^{- 1} * {JM}_{X} = {I}^{- 1} * [ \begin{matrix}{s}_{1}^{T} & {( {b}_{1} - {s}_{1} )}^{T} \\ {s}_{2}^{T} & {( {b}_{2} - {s}_{2} )}^{T} \\ ⋮ & ⋮ \\ {s}_{n}^{T} & {( {b}_{n} - {s}_{n} )}^{T}\end{matrix} ] \qquad [ Equation 4 ]$$

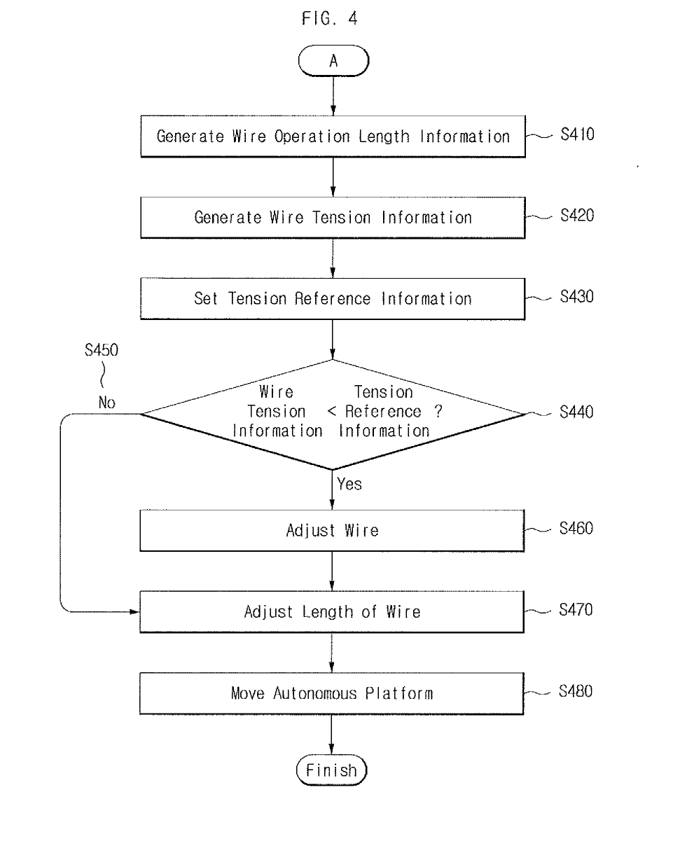

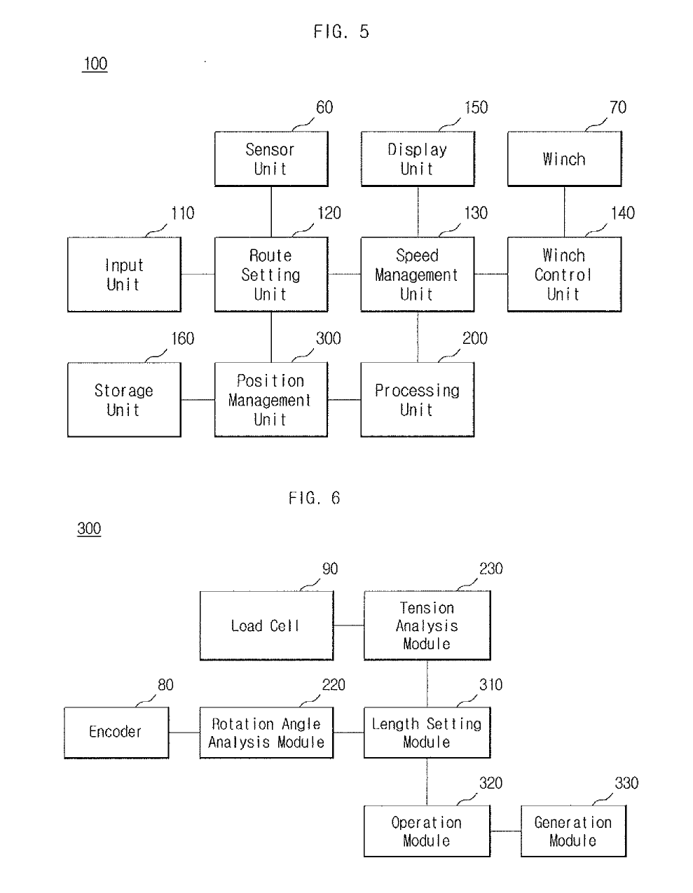

Here, JM_{L} is a unit matrix (l), and, as shown in FIGS. 5 and 6, sₙ is a unit vector from Aₙ, which is a position at which the “n”th wire 20 is fixed to the autonomous platform 10, to Bₙ, which is a position at which the “n”th wire 20 is fixed to the block 50, and bₙ is a vector from a center of a robot to Aₙ, and N is a natural number. Therefore, the generation module 270 calculates sₙ and bₙ by use of the length difference value and the block fixing position value of the block design information. Moreover, the generation module 270 generates the current position information by substituting the calculated sₙ and bₙ into [Equation 4].

The autonomous platform control system 100 generates the position difference information by comparing the current position information with the moved position information of the movement control information and generates the wire operation length information by use of the position difference information (S410).

That is, the length management module 280 of the autonomous platform control system 100 can define the wire operation length information as [Equation 5].

Lₙ=∥Aₙ−Bₙ∥=\sqrt{(^{w}Xₙ−^{w}xₙ)²+(^{w}Yₙ−^{w}yₙ)²+(^{w}Zₙ−^{w}zₙ)²} [Equation 5]
whereas, Aₙ=(^{w}xₙ, ^{w}yₙ, ^{w}zₙ),Bₙ=(^{w}Xₙ, ^{w}Yₙ, ^{w}Zₙ)

Here, L is wire operation length information, and, as shown in FIG. 6, Aₙ is a wire fixing position value at which the “n”th wire 20 is fixed to the autonomous platform 10, and Bₙ is a block fixing position value at which the “n”th wire 20 is fixed to the block 50, and N is a natural number that indicates the number of wires 20 connected to the autonomous platform 10. ^{w}xₙ, ^{w}yₙ, ^{w}zₙ is a wire fixing position value defined in a global coordinate system at which the “n”th wire 20 is fixed to the autonomous platform 10, and ^{w}Xₙ, ^{w}Yₙ, ^{w}Zₙ is a block fixing position value defined in the global coordinate system at which the “n”th wire 20 is fixed to the block 50. Here, since Bₙ is a position at which the “n”th wire 20 is fixed to the block 50 and thus does not change even if the autonomous platform 10 moves, Bₙ can be checked using the block fixing position value of the block design information.

The length management module 280 can define A as shown in [Equation 6].

$$[ \begin{matrix}{}_{}^{w}{x}{}_{n}^{} \\ {}_{}^{w}{y}{}_{n}^{} \\ {}_{}^{w}{z}{}_{n}^{} \\ 1\end{matrix} ] = [ \begin{matrix}{R}_{3 * 3} & {T}_{3 * 1} \\ {0}_{1 * 3} & {1}_{1 * 1}\end{matrix} ] [ \begin{matrix}{}_{}^{b}{x}{}_{n}^{} \\ {}_{}^{b}{y}{}_{n}^{} \\ {}_{}^{b}{z}{}_{n}^{} \\ 1\end{matrix} ] \\ whereas , \\ {R}_{3 * 3} = [ \begin{matrix}{c}_{z} {c}_{y} & {c}_{z} {s}_{y} {s}_{x} - {s}_{z} {c}_{x} & {c}_{z} {s}_{y} {c}_{x} + {s}_{z} {s}_{z} \\ {s}_{z} {c}_{y} & {s}_{z} {s}_{y} {s}_{x} + {c}_{z} {c}_{x} & {c}_{z} {s}_{y} {c}_{x} - {c}_{z} {s}_{x} \\ - {s}_{y} & {c}_{y} {s}_{x} & {c}_{y} {c}_{x}\end{matrix} ] , \\ {T}_{3 * 1} = [ \begin{matrix}{P}_{x} \\ {P}_{y} \\ {P}_{z}\end{matrix} ] \qquad [ Equation 6 ]$$

Here, R is a rotation matrix, and T is a translation matrix. ^{b}xₙ, ^{b}yₙ and ^{b}zₙ are platform fixing position values defined in a local coordinate system at which the “n”th wire 20 is fixed to the autonomous platform 10. Here, since ^{b}xₙ, ^{b}yₙ and ^{b}zₙ determine fixing position points of the wire 20 with reference to the autonomous platform 10 and thus do not change even if the autonomous platform moves, ^{b}xₙ, ^{b}yₙ and ^{b}zₙ can be checked using the platform fixing position values included in the block design information. c_{θ} and s_{θ} can be cos θ and sin θ. Pₓ, P_{y} and P_{z} indicate the position and posture of the autonomous platform 10 in the global coordinate system.

Accordingly, the length management module 280 generates wire fixing position value Aₙ by substituting the platform fixing position values of the block design information in ^{b}xₙ, ^{b}yₙ and ^{b}zₙ and substituting information obtained by adding the current position information, the position difference information and the position unit information with one another in Pₓ, P_{y} and P_{z}.

The length management module 280 generates the wire operation length information by substituting the generated wire fixing position value in Aₙ and substituting the block fixing position value of the block design information in Bₙ of [Equation 5].

The autonomous platform control system 100 generates the measurement information of wire tension that indicates the tension acting on the wire 20 (S420).

The autonomous platform control system 100 sets the tension reference information that becomes a reference for determining sagging of the wire 20 (S430).

The autonomous platform control system 100 determines whether the measurement information of wire tension is smaller than the tension reference information (S440).

If the measurement information of wire tension is determined to be equal to or greater than or equal to the tension reference information, the sagging management unit 170 of the autonomous platform control system 100 determines that no sagging has occurred in the wire 20 and adjusts the length of the wire 20 in order to move the autonomous platform 10 (S450). A method of adjusting the length of the wire 20 will be described in detail with reference to step S470.

If the measurement information of wire tension is determined to be smaller than the tension reference information, the autonomous platform control system 100 adjusts the wire 20 by use of the tension comparison information generated by comparing the measurement information of wire tension with the tension reference information (S460). For example, the sagging management unit 170 of the autonomous platform control system 100 can define the tension comparison information as shown in [Equation 7].

TS=Kₜ*((Tₙ)ₜ−(Tₙ)_{c}) [Equation 7]

Here, TS is tension comparison information, and Kₜ is a tension proportional gain for compensating tension information, and (Tₙ)ₜ is tension reference information, and (Tₙ)_{c} is wire tension measurement information. Here, the sagging management unit 170 can set the tension proportional gain by having the tension proportional gain inputted by the user or by using a predetermined algorithm.

The sagging management unit 170 sets the tension comparison information by substituting the tension reference information in (Tₙ)ₜ of [Equation 7] and substituting the measurement information of wire tension in (Tₙ)_{c}. The autonomous platform control system 100 can use the tension comparison information to solve the sagging occurred in the wire 20.

The autonomous platform control system 100 generates the rotation angle prediction information by using the wire operation length information and adjusts the length of the wire 20 by using the movement control information generated by comparing the rotation angle prediction information with the rotation angle measurement value (S470).

That is, the length management module 280 of the autonomous platform control system 100 can define the movement control information as shown in [Equation 8].

CL=Kₚ*((Jₙ)ₜ−(Jₙ)_{c}) [Equation 8]

Here, CL is movement control information, and Kₚ is a rotation angle proportional gain for compensating rotation angle information, (Jₙ)ₜ rotation angle prediction information, and (Jₙ)_{c} a rotation angle measurement value. Here, the length management module 280 can set length proportional gain by having the length proportional gain inputted by the user or by using a predetermined algorithm.

The length management module 280 sets the movement control information by substituting the rotation angle prediction information in (Jₙ)ₜ of [Equation 8] and substituting rotation angle measurement information in (Jₙ)_{c}.

The autonomous platform control system 100 controls the speed of the autonomous platform 10 and moves the autonomous platform 10 by using the movement control information and the movement speed information of the movement control information (S480).

Afterwards, the speed management unit 130 of the autonomous platform control system 100 stops moving the autonomous platform 10 if the measurement information of wire tension is greater than the tension reference information and a comparison value between the current position information and the final position information is smaller than position reference information. Here, the position reference information is a reference for determining a tolerable error by comparing the position and posture to which the autonomous platform needs to move with the current position and posture of the autonomous platform, and can be set by having the position reference information inputted by the user or by using a predetermined algorithm.

Hereinafter, a system for controlling an autonomous platform using a wire in accordance with an embodiment will be described with reference to FIGS. 5 to 7.

FIG. 5 is a block diagram illustrating a system for controlling an autonomous platform using a wire in accordance with an embodiment of the present invention.

Referring to FIG. 5, an autonomous platform control system 100 includes an input unit 110, a route setting unit 120, a speed management unit 130, a winch control unit, a position management unit 300, a processing unit 200, a display unit 150 and a storage unit 160.

The input unit 110 can have final position information inputted by a user. Here, the final position information indicates a position and posture to which an autonomous platform 10 needs to move eventually in a block 50. Here, the position of the autonomous platform 10 can be expressed as a coordinate value including x, y and z to indicate where the autonomous platform 10 is positioned in the block 50. Here, the position of the autonomous platform 10 indicates where the autonomous platform 10 is positioned in the block 50. The posture of the autonomous platform 10 can be expressed as an angle by which the autonomous platform 10 is tilted by a wire 20. The final position information can include at least one of a local coordinate value, which is based on the autonomous platform 10, and a global coordinate value, which is based on any one point within the block 50.

Moreover, the input unit 110 can have block design information inputted therein by the user. Here, the block design information can include a wire fixing position value for a position at which the wire 20 is fixed to the autonomous platform 10, a block fixing position value for a position at which the wire 20 is fixed to the block 50, and physical property information such as the size of the autonomous platform 10. The block design information can be received from an external device (not shown) that is connected with the autonomous platform control system 100.

The route setting unit 120 generates movement control information of the autonomous platform 10 by use of the final position information and initial position information. Here, the initial position information refers to a position and posture of the autonomous platform 10 before the autonomous platform 10 is moved, and is expresses as a coordinate value, like the final position information. The movement control information refers to control information required for moving the autonomous platform 10 from the initial position information to the final position information.

Specifically, the route setting unit 120 sets the initial position information indicating the position and posture of the autonomous platform 10 prior to moving. The route setting unit 120 can set the initial position information by using a sensor value inputted through a sensor unit 60 or by using wire initial length information provided by the position management unit 300. Here, the wire initial length information refers to a length of the wire 20 unwound from the winch 70 before the autonomous platform 10 is moved.

The route setting unit 120 uses the final position information and the initial position information to determine a movement route through which the autonomous platform 10 needs to move. Here, the movement route refers to a route through which the autonomous platform 10 needs to move from the initial position information to the final position information.

The route setting unit 120 generates movement speed information indicating a speed at which the autonomous platform 10 needs to move through the movement route per unit time. The route setting unit 120 generates the movement speed information that includes acceleration section information, constant speed section information and deceleration section information. Here, the route setting unit 120 can set the acceleration section information, the constant speed section information and the deceleration section information by receiving an input from the user through the input unit 110 or by using a predetermined algorithm (e.g., a program, a probability model, etc.).

The route setting unit 120 sets moved position information which indicates a position and posture to which the autonomous platform 10 needs to move per unit time. That is, the moved position information refers to the position and posture to which the autonomous platform 10 needs to have moved after a unit time.

The route setting unit 120 sets the movement control information that includes at least one of the movement speed information and the moved position information. Moreover, the route setting unit 120 can set position unit information, which indicates a position and posture to which the autonomous platform 10 needs to move per unit time, and have the position unit information included in the movement control information. Here, the position unit information refers to information on how much the autonomous platform 10 needs to move per unit time according to the movement speed information.

The route setting unit 120 sets rotation angle processing information corresponding to the final position information. Here, the rotation angle processing information can show a rotation angle of the winch 70 corresponding to the position and posture to which the autonomous platform 100 needs to move per unit time.

The speed management unit 130 uses the movement control information to move the autonomous platform 10. In other words, the speed management unit 130 can generate wire unit length information by setting a length of the wire 20 per unit time based on the movement speed information. The speed management unit 130 provides the wire unit length information to the winch control unit 140.

The winch control unit 140 is accessed with the winch 70 and adjusts the length of the wire 20 by controlling the winch 70, on which the wire 20 is wound, to move the autonomous platform connected with the wire 20. For instance, the winch control unit 140 can control the winch 70 by use of the wire unit length information provided by the speed management unit 130 to wind or unwind the wire 20 to move the autonomous platform 10.

The position management unit 300 uses rotation angle measurement information and wire tension information to generate current position information. In other words, the position management unit 300 generates current length information of the wire by using the rotation angle measurement information for the wire 20 and the autonomous platform 10 and the wire tension information acting on the wire 20.

Here, the rotation angle measurement information refers to an angle of the winch 70 when the winch 70 winds or unwinds the wire 20. The wire tension information refers to a tension acting on the wire 20 and can include tension information for each of a plurality of wires 20 connected to the autonomous platform 10. The current length information of the wire refers to a length of the wire 20 that is unwound from the winch 70, which is a length of the wire 20 connecting the autonomous platform 10 with the block 50. The current length information of the wire can include lengths for each of the plurality of wires 20 connected to the autonomous platform 10.

The position management unit 300 uses the current length information of the wire to generate the current position information. Here, the current position information can refer to a position and posture at which the autonomous platform 10 is currently placed within the block 50. The position management unit 300 will be described in more detail with reference to FIG. 2.

The processing unit 200 uses the current position information to generate wire operation length information and rotation angle control information. That is, the processing unit 200 generates the wire operation length information, which indicates a length of the wire 20 at a position and posture to which the autonomous platform 10 needs to move, by using the current position information and the moved position information of the movement control information. Here, the rotation angle control information refers to a rotation angle of the winch 70 for moving the autonomous platform 10 to the moved position information. The processing unit will be described in more detail with reference to FIG. 3.

The display unit 150 can display steps carried out and results outputted by the input unit 110, the route setting unit 120, the speed management unit 130, the winch control unit 140, the position management unit 300 and the processing unit 200 and can display data stored in the storage unit 160.

For example, the display unit 150 can display a user interface in order to have movement initial information inputted by the user. The user can check displayed information through the display unit 150 and input the movement initial information through the input unit 110.

In another example, the display unit 150 can display the steps and results of having the initial position information and the movement control information set by the route setting unit 120 and display the sensor value measured by the sensor unit 60.

In another example, the display unit 150 can display the steps and results of having the current length information and the current position information generated by the position management unit 300 and display the steps and results of having the wire operation length information generated by the processing unit 200.

Moreover, the display unit 150 can display any error occurred in the input unit 110, the route setting unit 120, the speed management unit 130, the winch control unit 140, the position management unit 300 the processing unit 200. Accordingly, the user can check the error displayed through the display unit 150 and solve the error.

The storage unit 160 stores data required or generated for moving the autonomous platform 10. That is, the storage unit 160 can store data required or generated by the input unit 110, the route setting unit 120, the speed management unit 130, the winch control unit 140, the position management unit 300 and the processing unit 200, which are component elements of the autonomous platform control system 100.

For example, the storage unit 160 can store the final position information inputted through the input unit 110 and the sensor value measured through the sensor unit 60.

In another example, the storage unit 160 can store the current length information and the current position information generated by the position management unit 300 and store the wire operation length information generated by the processing unit 200.

Moreover, the storage unit 160 can provide data required according to a request of the input unit 110, the route setting unit 120, the speed management unit 130, the winch control unit 140, the position management unit 300, the processing unit 200 or the display unit 150.

FIG. 6 is a block diagram illustrating a detailed configuration of the position management unit of the system for controlling an autonomous platform using a wire shown in FIG. 5.

Referring to FIG. 6, the position management unit 300 includes a rotation angle analysis module 220, a tension analysis module 230, a length setting module 310, an operation module 320 and a generation module 330.

The rotation angle analysis module 220 uses rotation angle measurement value of the winch 70 that is measured by an encoder 80 to generate base length information of the wire that indicates the length of the wire 20 unwound from the winch 70.

For example, the rotation angle analysis module 220 can express a relation between the rotation angle measurement information and length information of the wire 20 as a function and insert the rotation angle measurement information in the function to generate the base length information of the wire. It is also possible for the rotation angle analysis module 220 to generate the base length information of the wire by use of a length table in which lengths of the wire 20 are matched to rotation angle information.

Here, the encoder 80 is connected to the winch 70 and generates the rotation angle measurement information through a rotation of the winch 70. Moreover, the encoder 80 is connected to a pulley (not shown) that discharges the wire 20 to measure how much the pulley is rotated or to generate the rotation angle measurement information by measuring an amount of the discharged wire 20.

Moreover, once a length request signal is received from the route setting unit 120, the rotation angle analysis module 220 generates the wire initial length information by measuring the rotation angle measurement information of the winch 70, prior to moving, mounted in the autonomous platform, through the encoder 80 connected to an axle of the winch 70. Moreover, the rotation angle analysis module 220 provides the wire initial length information to the route setting unit 120.

The tension analysis module 230 generates the wire tension information by use of tension measurement information measured at a load cell 90.

For example, the tension analysis module 230 can express a relation between the tension measurement information measured at the load cell 90 and a wire tension acting on the wire 20 as a linear or non-linear function and can generate the wire tension information by inserting the tension measurement information in the function. It is also possible for the tension analysis module 230 to generate the wire tension information by use of a tension table in which wire tensions acting on the wire 20 are matched to the tension measurement information.

Here, the load cell 90 is connected to the wire 20 and generates the tension measurement information by measuring the tension acting on the wire 20. The load cell 90 is accessed to the tension analysis module 230 and sends the tension measurement information to the tension analysis module 230.

The length setting module 310 uses the base length information of the wire and the wire tension information to generate the current length information of the wire. In other words, the length setting module 310 can generate the current length information of the wire by reflecting the wire tension information in the base length information of the wire.

Therefore, the autonomous platform control system 100 using the wire 20 in accordance with the present invention can determine a precise position and posture of the autonomous platform 10 in the block 50 because the current length information of the wire is generated using the tension acting on the wire 20.

The operation module 320 sets arbitrary position information of the autonomous platform 10 and then sets arbitrary length information for the arbitrary position information. Specifically, the operation module 320 sets the arbitrary position information in order to assume that the autonomous platform 10 is placed at an arbitrary position within the block 50 to which the autonomous platform 10 is fixed. Here, the arbitrary position information refers to a position where the autonomous platform 10 is virtually placed within the block 50 and can be expressed as a coordinate value. The arbitrary position information can be any place as long as the autonomous platform can be moved to such a place within the block 50. The arbitrary position information can be set by the operation module 320 by having the arbitrary position information inputted by the user through the input unit 110 or by use of a predetermined algorithm.

The operation module 320 uses the arbitrary position information to set the arbitrary length information through inverse kinematics. Here, the arbitrary length information of the wire can refer to a length of the wire 20 unwound from the winch 70 with respect to the arbitrary position information and can include lengths of the plurality of wires 20 connected to the autonomous platform 10.

The generation module 330 uses the arbitrary length information of the wire and the current length information of the wire to generate the current position information through forward kinematics. In other words, the generation module 330 generates a length difference value by comparing the arbitrary length information of the wire and the wire operation length information. The generation module 270 can set length reference information, which is a reference for tolerating an error, by comparing the arbitrary length information of the wire with the current length information of the wire. Here, the generation module 330 can set the length reference information by having the length reference information inputted by the user through the input unit 110 or by using a predetermined algorithm.

The generation module 330 determines whether the length difference value is smaller than the length reference information. If the length difference value is determined to be smaller than the length reference information, the generation module 330 generates the current position information with the arbitrary position information.

If, however, the length difference value is determined to be greater than or equal to the length reference information, the generation module 330 can generate the current position information by re-setting the arbitrary position information by use of the length difference value.

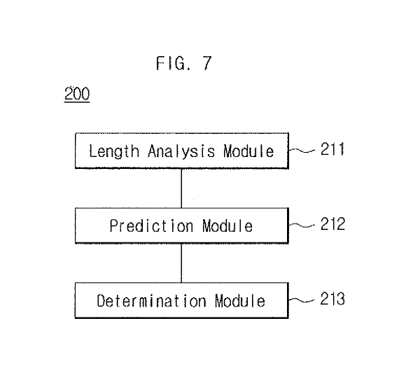

FIG. 7 is a block diagram illustrating in detail the processing unit of the system for controlling an autonomous platform using a wire shown in FIG. 5.

Referring to FIG. 7, the processing unit 200 includes a length analysis module 211, a prediction module 212 and a determination module 213.

The length analysis module 211 uses the current position information and the movement control information to generate the wire operation length information. That is, the length analysis module 211 generates position difference information by comparing the current position information with the moved position information included in the movement control information in order to determine whether the autonomous platform 10 has moved based on the movement control information set by the route setting unit 120.

Moreover, the length analysis module 211 generates the wire operation length information by adding the current position information, the position difference information and position unit information included in the movement control information with one another. Here, the wire operation length information refers to a length of the wire 20 connecting the block 50 with the autonomous platform 10 that is placed at a position and posture to which the autonomous platform 10 needs to move per unit time. Meanwhile, the length analysis module 211 can generate the wire operation length information by using the current position information, the position difference information and the movement control information through inverse kinematics.

The prediction module 212 uses the wire operation length information to generate rotation angle prediction information, which refers to a rotation angle of the autonomous platform 10 and the winch 70 for moving the autonomous platform 10.

In other words, the prediction module 212 can generate tension prediction information corresponding to the wire operation length information. The prediction module 212 uses the wire operation length information and the tension prediction information to generate the rotation angle prediction information. For example, the prediction module 212 can express a relation between the rotation angle information and length information of the wire 20 as a function and input the wire operation length information in the function to generate the rotation angle prediction information. Moreover, it is also possible for the prediction module 212 to generate the rotation angle prediction information by using the rotation angle information that is matched to the wire operation length information in the length table.

The determination module 213 uses the rotation angle measurement information and the rotation angle prediction information to generate the rotation angle control information. That is, the determination module 213 can generate the rotation angle control information by comparing the rotation angle measurement information with the rotation angle prediction information in order to move the autonomous platform 10 from a position and posture at which the autonomous platform 10 is currently placed in the block 50 to a position and posture to which the autonomous platform 10 needs to move.

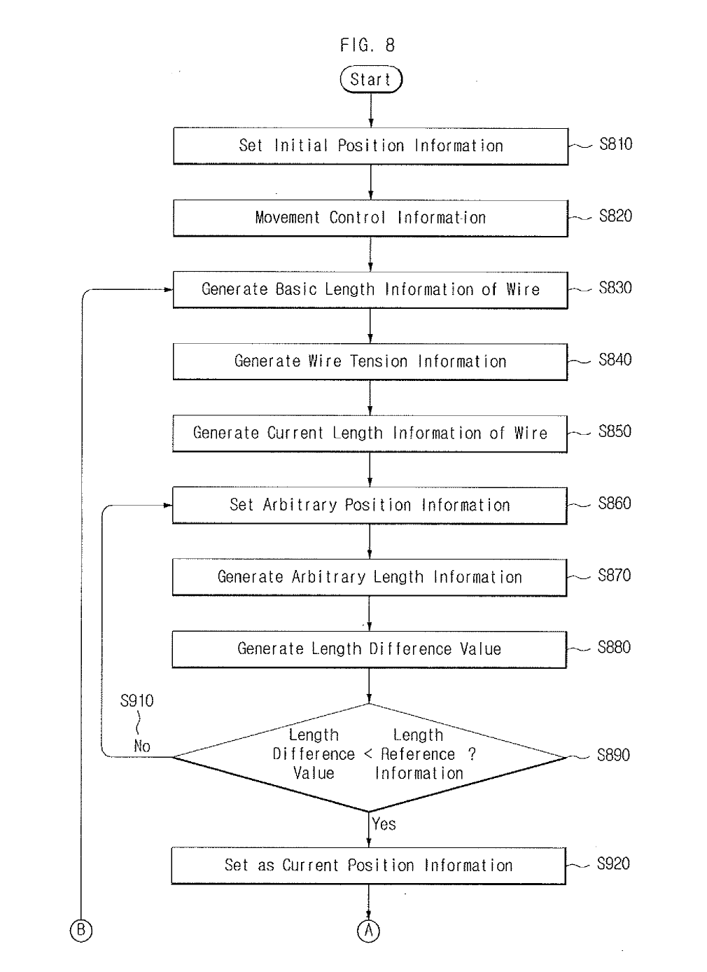

A method for allowing the autonomous platform control system using a wire in accordance with an embodiment of the present invention to control the autonomous platform will be described with reference to FIGS. 8 and 9.

FIGS. 8 and 9 are detailed flow diagrams illustrating a method for controlling an autonomous platform using a wire in accordance with an embodiment of the present invention.

Referring to FIGS. 8 and 9, the autonomous platform control system 100 sets the initial position information indicating the position and posture of the autonomous platform before the autonomous platform 10 is moved (S810).

The autonomous platform control system 100 sets the movement control information including at least one of the movement speed information, the moved position information and the position unit information, using the final position information and the initial position information (S820). Then, the autonomous platform control system 100 uses the movement speed information of the movement control information to generate the wire unit length information and moves the autonomous platform 10 by loosening or pulling the plurality of wires 20 connected to the autonomous platform 10 by use of the movement speed information and the wire unit length information.

The autonomous platform control system 100 generates the base length information of the wire by use of the rotation angle measurement information of the winch 70 (S830).

The autonomous platform control system 100 generates the wire tension information acting on the wire 20 (S840).

The autonomous platform control system 100 generates the current length information of the wire by use of the base length information of the wire and the wire tension information (S850).

The autonomous platform control system 100 sets the arbitrary position information of the autonomous platform 10 in order to assume that the autonomous platform 10 is placed at an arbitrary position within the block 50 (S860).

The autonomous platform control system 100 sets the arbitrary length information of the wire by substituting the arbitrary position information in inverse kinematics (S870).

The autonomous platform control system 100 generates the length difference value by comparing the current length information of the wire with the arbitrary length information of the wire (S880).

Specifically, the generation module 330 of the autonomous platform control system 100 can define the length difference value as shown in [Equation 9].

D=Lₘ−Lₖ [Equation 9]

Here, D is a length difference value, and Lₘ is current length information of the wire, and Lₖ is arbitrary length information of the wire. Accordingly, the generation module 330 generates the length difference value by inputting the current length information of the wire generated by the length setting module 310 in Lₘ of [Equation 1] and inputting the arbitrary length information of the wire set by the operation module 320 in Lₖ of [Equation 1]. Here, the generation module 330 can generate the length difference value to correspond to each of the plurality of wires 20 connected to the autonomous platform 10.

The autonomous platform control system 100 determines whether the length difference value is smaller than the length reference information (S890).

The autonomous platform control system 100 re-sets the arbitrary position information by returning to step S860 and using the length difference value if the length difference value is determined to be greater than or equal to the length reference information (S910).

The autonomous platform control system 100 generates the current position information by inputting the arbitrary position information in forward kinematics if the length difference value is determined to be smaller than the length reference information (S920).

That is, the generation module 330 of the autonomous platform control system 100 can generate the current position information by use of [Equation 10].

Xₖ₊₁=Xₖ+JM^{#}[D] [Equation 10]

Here, Xₖ₊₁ refers to a position and posture to which the autonomous platform 10 moves using the movement control information with respect to Xₖ, which is arbitrary position information, and JM is the Jacobian matrix that is determined by the kinematic shape of the wire 20, and D is a length difference value.

The generation module 330 can convert [Equation 10] to [Equation 11].

JM_{X}\dot{X}=JM_{L}\dot{L} [Equation 11]

Here, JM_{X}\dot{X} means that a value obtained by subtracting Xₖ from Xₖ₊₁ is differentiated, and JM_{L}\dot{L} means that a value obtained by subtracting Lₖ from Lₘ is differentiated. Afterwards, the generation module 330 can convert [Equation 11] to [Equation 12] in order to generate the current position information.

$$JM = {JM}_{L}^{- 1} * {JM}_{X} = {I}^{- 1} * [ \begin{matrix}{s}_{1}^{T} & {( {b}_{1} - {s}_{1} )}^{T} \\ {s}_{2}^{T} & {( {b}_{2} - {s}_{2} )}^{T} \\ ⋮ & ⋮ \\ {s}_{n}^{T} & {( {b}_{n} - {s}_{n} )}^{T}\end{matrix} ] \qquad [ Equation 12 ]$$

Here, JM_{L} is a unit matrix (l), and, as shown in FIGS. 6 and 7, sₙ is a unit vector from Aₙ, which is a position at which the wire 20 is fixed to the autonomous platform 10, to Bₙ, which is a position at which the wire 20 is fixed to the block 50, and bₙ is a vector from a center of a robot to Aₙ, and N is a natural number.

Therefore, the generation module 330 calculates sₙ and bₙ by use of the length difference value and the block fixing position value of the block design information. Moreover, the generation module 330 generates the current position information by substituting the calculated sₙ and bₙ into [Equation 12].

The autonomous platform control system 100 generates the wire operation length information by adding the current position information, the position difference information and the position unit information of the movement control information with one another and inputting said addition to inverse kinematics (S930).

That is, the length analysis module 211 of the autonomous platform control system 100 can define the wire operation length information as [Equation 13].

Lₙ=∥Aₙ−Bₙ∥=\sqrt{(^{w}Xₙ−^{w}xₙ)²+(^{w}Yₙ−^{w}yₙ)²+(^{w}Zₙ−^{w}zₙ)²} [Equation 13]
whereas, Aₙ=(^{w}xₙ, ^{w}yₙ, ^{w}zₙ),Bₙ=(^{w}Xₙ, ^{w}Yₙ, ^{w}Zₙ)

Here, L is wire operation length information, and, as shown in FIG. 7, Aₙ is a wire fixing position value at which the wire 20 is fixed to the autonomous platform 10, and Bₙ is a block fixing position value at which the wire 20 is fixed to the block 50, and N is a natural number that indicates the number of wires 20 connected to the autonomous platform 10. ^{w}xₙ, ^{w}yₙ, ^{w}zₙ is a wire fixing position value defined in a global coordinate system at which the “n”th wire 20 is fixed to the autonomous platform 10, and ^{w}Xₙ, ^{w}Yₙ, ^{w}Zₙ is a block fixing position value defined in the global coordinate system at which the “n”th wire 20 is fixed to the block 50. Here, since Bₙ is a position at which the wire 20 is fixed to the block 50 and thus does not change even if the autonomous platform 10 moves, Bₙ can be checked using the block fixing position value of the block design information.

The length analysis module 211 can define Aₙ as shown in [Equation 14].

$$[ \begin{matrix}{}_{}^{w}{x}{}_{n}^{} \\ {}_{}^{w}{y}{}_{n}^{} \\ {}_{}^{w}{z}{}_{n}^{} \\ 1\end{matrix} ] = [ \begin{matrix}{R}_{3 * 3} & {T}_{3 * 1} \\ {0}_{1 * 3} & {1}_{1 * 1}\end{matrix} ] [ \begin{matrix}{}_{}^{b}{x}{}_{n}^{} \\ {}_{}^{b}{y}{}_{n}^{} \\ {}_{}^{b}{z}{}_{n}^{} \\ 1\end{matrix} ] \\ whereas , \\ {R}_{3 * 3} = [ \begin{matrix}{c}_{z} {c}_{y} & {c}_{z} {s}_{y} {s}_{x} - {s}_{z} {c}_{x} & {c}_{z} {s}_{y} {c}_{x} + {s}_{z} {s}_{x} \\ {s}_{z} {c}_{y} & {s}_{z} {s}_{y} {s}_{x} + {c}_{z} {c}_{x} & {c}_{z} {s}_{y} {c}_{x} - {c}_{z} {s}_{x} \\ - {s}_{y} & {c}_{y} {s}_{x} & {c}_{y} {c}_{x}\end{matrix} ] , \\ {T}_{3 * 1} = [ \begin{matrix}{P}_{x} \\ {P}_{y} \\ {P}_{z}\end{matrix} ] \qquad [ Equation 14 ]$$

Here, R is a rotation matrix, and T is a translation matrix. ^{b}xₙ, ^{b}yₙ and ^{b}Zₙ are platform fixing position values defined in a local coordinate system at which the “n”th wire 20 is fixed to the autonomous platform 10. Here, since ^{b}xₙ, ^{b}yₙ and ^{b}Zₙ determine fixing position points of the wire 20 with reference to the autonomous platform 10 and thus do not change even if the autonomous platform moves, ^{b}xₙ, ^{b}yₙ and ^{b}Zₙ can be checked using the platform fixing position values included in the block design information. c_{θ} and s_{θ} are cos θ and sin θ, respectively. Pₓ, P_{y} and P_{z} indicate the position and posture of the autonomous platform 10 in the global coordinate system.

Accordingly, the length analysis module 211 generates wire fixing position value Aₙ by substituting the platform fixing position values of the block design information in ^{b}xₙ, ^{b}yₙ and ^{b}Zₙ and substituting information obtained by adding the current position information, the position difference information and the position unit information with one another in Pₓ, P_{y} and P_{z}. The length analysis module 211 generates the wire operation length information by substituting the generated wire fixing position value in Aₙ and substituting the block fixing position value of the block design information in B, of [Equation 13].

The autonomous platform control system 100 generates the tension prediction information corresponding to the wire operation length information (S940).

The autonomous platform control system 100 generates the rotation angle prediction information by using the wire operation length information and the tension prediction information (S950).

The autonomous platform control system 100 generates the rotation angle control information by comparing the rotation angle measurement information with the rotation angle prediction information (S960).

That is, the prediction module 212 of the autonomous platform control system 100 can define the rotation angle control information as shown in [Equation 15].

CL=Kₚ*((Jₙ)ₜ−(Jₙ)_{c}) [Equation 15]

Here, CL is rotation angle control information, and Kₚ is a rotation angle proportional gain for compensating rotation angle information, (Jₙ)ₜ rotation angle prediction information, and (Jₙ)_{c} rotation angle measurement information. Here, the prediction module 212 can set the rotation angle proportional gain by having the rotation angle proportional gain inputted by the user or by using a predetermined algorithm.

The prediction module 212 sets the rotation angle control information by substituting the rotation angle prediction information in (Jₙ)ₜ of [Equation 15] and substituting the rotation angle measurement information in (Jₙ)_{c}.

The autonomous platform control system 100 moves the autonomous platform 10 toward the final position information by using the rotation angle control information and the movement speed information of the movement control information (S970).

The autonomous platform control system 100 determines whether rotation angle difference information is smaller than rotation angle reference information (S980). That is, the route setting unit 120 of the autonomous platform control system 100 can set the rotation angle difference information by subtracting the rotation angle prediction information from rotation angle process information in order to determine whether the autonomous platform 10 has arrived at the final position information. The route setting unit 120 determines whether the rotation angle difference information is smaller than the rotation angle reference information. Here, the rotation angle reference information is information that becomes a reference for determining whether the autonomous platform 10 has arrived at the final position information and can be set by the route setting unit 120 by having the rotation angle reference information inputted by the user or by use of a predetermined algorithm.

If the rotation angle difference information is determined to be smaller than the rotation angle reference information by the route setting unit 120 of the autonomous platform control system 100, the autonomous platform 10 stops moving because the autonomous platform has arrived at the final position information (S990).

If the rotation angle difference information is determined to be greater than or equal to the rotation angle reference information by the route setting unit 120 of the autonomous platform control system 100, the autonomous platform 10 has not arrived at the final position information, and thus the method can be repeated from step S80 to move the autonomous platform 10 until the rotation angle difference information becomes smaller than the rotation angle reference information (S1010).

Although certain embodiments of the present invention have been described, it shall be appreciated by those who are ordinarily skilled in the art to which the present invention pertains that various modifications and permutations of the present invention are possible without departing from the technical ideas and scope of the present invention that are defined in the claims appended below.

### INDUSTRIAL APPLICABILITY

The system and method for controlling an autonomous platform using a wire in accordance with an embodiment of the present invention can prevent the wire connected to the autonomous platform from sagging.

Moreover, the system and method for controlling an autonomous platform using a wire in accordance with an embodiment of the present invention can control the tension acting on the wire so as to prevent the wire from sagging.

Moreover, the system and method for controlling an autonomous platform using a wire in accordance with an embodiment of the present invention can control the speed of the wire and thus can move the autonomous platform to a desired position and posture.

Moreover, the system and method for controlling an autonomous platform using a wire in accordance with an embodiment of the present invention can precisely determine the length of the wire fixed within the block.

Moreover, the system and method for controlling an autonomous platform using a wire in accordance with an embodiment of the present invention can precisely determine the length of the wire fixed to the autonomous platform and the block by use of the tension acting on the wire.

What is claimed is:

1. A system for controlling an autonomous platform connected with a wire, the system comprising:
a route setting unit configured to generate movement control information by using final position information and initial position information;
a speed management unit configured to move the autonomous platform by controlling a speed of the autonomous platform by use of the movement control information;
a processing unit configured to generate current position information by using a rotation angle measurement value with respect to the wire and the moved autonomous platform and configured to generate wire operation length information by using the current position information and the movement control information; and
a sagging management unit configured to determine sagging of the wire by using measurement information of wire tension acting on the wire once the wire operation length information is generated and configured to adjust the wire by using the measurement information of wire tension if it is determined that the sagging of the wire has occurred.

2. The system of claim 1, wherein the sagging management unit is configured to set tension reference information, which becomes a reference for determining the sagging of the wire, and determine that the wire has sagged if the measurement information of wire tension is smaller than the tension reference information, and adjust the wire by using the wire tension measurement information.

3. The system of claim 2, wherein the sagging management unit is configured to generate tension comparison information by comparing the measurement information of wire tension with the tension reference information and pull the wire by using the tension comparison information.

4. The system of claim 1, wherein the processing unit comprises:
a wire management module configured to generate current length information of the wire by setting a length of the wire by use of the rotation angle measurement value;
a position management module configured to generate the current position information by using the current, length information of the wire;
a length management module configured to generate the wire operation length information by using the current position information and moved position information of the movement control information; and
a winch control module configured to move the autonomous platform, for which the sagging of the wire is solved, by winding or unwinding the wire by controlling a winch by use of the wire operation length information,
wherein the moved position information refers to a position and posture to which the autonomous platform needs to move per unit time.

5. (canceled)

6. The system of claim 4, wherein the position management module comprises:
a prediction module configured to set arbitrary position information, which indicates an arbitrary position within a block in which the autonomous platform is placed, and arbitrary length information of the wire by using the arbitrary position information; and
a generation module configure to the current position information by using the arbitrary length information of the wire and the current length information of the wire.

7. The system of claim 6, wherein the generation module is configured to generate a length difference value by comparing the arbitrary length information of the wire with the current length information of the wire, determine whether the length difference value is smaller than the length reference information, and generate the current position information with the arbitrary position information if the length difference value is determined to be smaller than the length reference information.

8. (canceled)

9. A system for controlling an autonomous platform connected with a wire, the system comprising:
a route setting unit configured to set movement control information by using final position information and initial position information;
a speed management unit configured to move the autonomous platform by controlling a speed of the autonomous platform by use of the movement control information;
a position management unit configured to generate current length information of the wire by using rotation angle measurement information with respect to the wire and the moved autonomous platform and by using wire tension information acting on the wire and configured to generate current position information of the moved autonomous platform by using the current length information of the wire; and
a processing unit configured to generate wire operation length information by using the current position information and the movement control information and generate rotation angle control information by using the wire operation length information and the rotation angle measurement information.

10. The system of claim 9, wherein the movement control information comprises at least one of movement speed information, at which the autonomous platform needs to move per unit time, and moved position information.

11. The system of claim 10, wherein the processing unit comprises:
an analysis module configured to generate the wire operation length information by using the current position information and the moved position information;
a prediction module configured to generate rotation angle prediction information by using the wire operation length information; and
a determination module configured to generate the rotation angle control information by comparing the rotation angle prediction information with the rotation angle measurement information.

12. The system of claim 11, wherein the prediction module is configured to generate tension prediction information corresponding to the wire operation length information and generate the rotation angle prediction information by using the wire operation length information and the tension prediction information.

13. The system of claim 9, wherein the position management unit comprises:
a rotation angle analysis module configured to generate base length information of the wire by using the rotation angle measurement information that is measured through an encoder connected to the wire;
a tension analysis module configured to generate the wire tension information by using tension measurement information that is measured through a load cell connected to the wire; and
a length setting module configured to generate the current length information of the wire by setting a length of the wire by using the base length information of the wire and the wire tension information.

14. The system of claim 13, wherein the position management unit further comprises:
an operation module configured to set arbitrary position information indicating a position where the autonomous platform is placed within a block and set arbitrary length information by using the arbitrary position information; and
a generation module configured to generate a length difference value by comparing the arbitrary length information of the wire with the current length information of the wire and set the arbitrary position information as the current position information if the length difference value is smaller than length reference information.

15. (canceled)

16. A method for controlling an autonomous platform using a wire, the autonomous platform being controlled by a system for controlling the autonomous platform using the wire, the method comprising:
(a) generating movement control information of the autonomous platform by using final position information and initial position information, and moving the autonomous platform by using the movement control information;
(b) generating current position information by setting a position and posture of the autonomous platform by using a rotation angle measurement value of a winch connected to the wire;
(c) generating wire operation length information by setting a length of the wire by using the current position information;
(d) determining sagging of the wire by using measurement information of wire tension acting on the wire, and if the sagging of the wire occurs, adjusting the wire by using the measurement information of wire tension; and
(e) moving the wire-sagging solved autonomous platform by controlling a speed of the autonomous platform by using the movement control information.

17. The method of claim 16, wherein said step (d) comprises:
generating the measurement information of wire tension by measuring a tension of the wire connected to the autonomous platform;
setting tension reference information which becomes a reference for determining sagging of the wire; and
determining that the wire is sagged if the measurement information of wire tension is smaller than the tension reference information, and adjusting the wire by using the measurement information of wire tension.

18. The method of claim 17, wherein said step (b) comprises:
(b1) generating current length information of the wire by setting a length of the wire by using the rotation angle measurement value; and
(b2) generating the current position information through forward kinematics by using the current length information of the wire.

19-22. (canceled)

23. A method for controlling an autonomous platform using a wire, the autonomous platform being controlled by a system for controlling the autonomous platform using the wire, the method comprising:
(a) setting movement control information by using final position information and initial position information, and moving the autonomous platform by using the movement control information;
(b) generating current length information of the wire by using rotation angle measurement information with respect to the wire and the moved autonomous platform and wire tension information acting on the wire;
(c) generating current position information of the moved autonomous platform by using the current length information of the wire;
(d) generating wire operation length information by using the current position information and the movement control information;
(e) moving the autonomous platform by using rotation angle control information setting the wire operation length information and the rotation angle measurement information.

24. The method of claim 23, wherein said step (a) comprises:
setting the movement control information comprising at least one of movement speed information, at which the autonomous platform needs to move per unit time, and moved position information by using the final position information and the initial position information; and
moving the autonomous platform by using the movement control information.

25. The method of claim 24, wherein said step (e) comprises:
generating tension prediction information corresponding to the wire operation length information;
generating rotation angle prediction information by using the wire operation length information and the tension prediction information; and
generating the rotation angle control information by comparing the rotation angle prediction information with the rotation angle measurement information.

26. (canceled)

27. The method of claim 23, wherein said step (b) comprises:
generating base length information of the wire by using the rotation angle measurement information measured through an encoder connected to the wire;
generating the wire tension information by using tension measurement information measured through a load cell connected to the wire; and
generating the current length information of the wire by setting a length of the wire by using the base length information of the wire and the wire tension information.

28. (canceled)

29. The method of claim 23, wherein said step (c) comprises:
setting arbitrary position information where the autonomous platform is placed within a block;
setting arbitrary length information of the wire by using the arbitrary position information;
generating a length difference value by comparing the arbitrary length information of the wire with the current length information of the wire; and
generating the current position information with the length difference value and the arbitrary position information if the length difference value is smaller than length reference information.
